(19) United States
(12) Patent Application Publication
(10) Pub. No.: US 2008/0287282 A1
(43) Pub. Date: Nov. 20, 2008

(54) PROCESS FOR RECOVERY OF RUTHENIUM FROM A RUTHENIUM-CONTAINING SUPPORTED CATALYST MATERIAL

(75) Inventors: Michel Haas, Dormagen (DE); Peter Weuta, Leverkusen (DE); Aurel Wolf, Wuelfrath (DE); Oliver Felix-Karl Schlueter, Leverkusen (DE)

Correspondence Address: CONNOLLY BOVE LODGE & HUTZ, LLP, P O BOX 2207, WILMINGTON, DE, 19899, US

(73) Assignee: Bayer MaterialScience AG, Leverkusen (DE)

(21) Appl. No.: 12/108,085

(22) Filed: Apr. 23, 2008

(30) Foreign Application Priority Data
Apr. 26, 2007 (DE) 102007020142.9

(51) Int. Cl. B01J 38/44; C01B 9/00

(52) U.S. Cl. 502/37; 423/491

(57) ABSTRACT

Process to recover ruthenium in the form of ruthenium halide, particularly ruthenium chloride, from a ruthenium-containing supported catalyst material comprising:
a) chemically decomposing the ruthenium-containing supported catalyst material;
b) producing a raw ruthenium salt solution;
c) purifying the raw ruthenium salt solution and optionally stripping gaseous ruthenium tetroxide from the raw ruthenium salt solution; and
d) treating the purified ruthenium compound obtained in c), particularly the ruthenium tetroxide, with hydrogen halide or hydrohalic acid to obtain ruthenium halide, particularly with hydrogen chloride or hydrochloric acid to obtain ruthenium chloride.

### RELATED APPLICATIONS

This application claims benefit to German Patent Application No. 10 2007 020 142.9, filed Apr. 26, 2007, which is incorporated herein by reference in its entirety for all useful purposes.

### BACKGROUND OF THE INVENTION

Ruthenium and ruthenium compounds are often ingredients of catalysts, but are not restricted to this application. Particularly ruthenium oxide, ruthenium mixed oxide, ruthenium chloride, ruthenium chloride oxides and metal ruthenium, both supported or unsupported, are used in many applications, among others catalysis. Ruthenium compounds are also often used in electrocatalytic procedures or in heterogeneous catalysis.

The ruthenium components can be particularly metal ruthenium as well as ruthenium chloride, ruthenium oxide or a species of chlorine-containing ruthenium oxide.

In view of the rarity of ruthenium, the recovery of this noble metal and its compounds represents an interesting alternative to purchasing new supplies of the noble metal. This method of approach has a very special economic advantage particularly for catalysts and electrodes used in industry, as catalysts and electrodes can contain significant amounts of ruthenium in these applications.

Known methods of approach for purifying ruthenium compounds are described in some patent specifications and unexamined patent applications. In general, however, these are not adequately efficient or cannot be developed on an industrial scale.

A method is described in EP 424 776 B1, in which an aqueous ruthenium-containing solution is purified, in the form of alkali ruthenate, by oxidation with ozone at a pH value exceeding 8 to ruthenium tetroxide. A particular disadvantage is the considerably complex procedure involved therein of at least a two-stage procedure (first converting the Ru-containing parent compound into an alkali ruthenate, then converting this ruthenate into RuO₄).

EP 1 026 283 A1 describes a method whereby metal ruthenium powder is purified, in order to produce metal ruthenium sputter targets of high purity. In this arrangement, the ruthenium is introduced into a sodium hydroxide solution and subsequently reacts with the addition of ozone-containing or chlorine-containing gas to form ruthenium tetroxide. In the next step, ruthenium tetroxide is absorbed by HCl or HCl/ammonium chloride and dried in a hydrogen atmosphere. The metal ruthenium powder thus obtained can be pressed into a target. A particular disadvantage is the high consumption of chlorine typical in implementing this process.

EP 1 072 690 describes a method to process ruthenium in the gas phase in the HCl stream and JP 01 142040 represents a course of action, in which ruthenium with chlorine is stripped in a reducing atmosphere at 600° C.-1200° C.

In a variation, the invention uses the effect, that ruthenium compounds, not present in solution, form highly volatile ruthenium tetroxide (RuO₄) in an oxygen-containing atmosphere at increased temperature. Such a method would have the considerable advantage, that the ruthenium would not have to be first dissolved in solution. However, this reaction in the presence of oxygen occurs very slowly and is not commercially viable due to the evaporation times, which are far too long, at very high temperatures.

The known methods have the disadvantage, that they are difficult to apply to oxide-based catalysts. In order to obtain purified ruthenium compounds originating from supported catalyst materials or electrode material (i.e. from supported ruthenium compounds), additional decomposition has to take place. This can take place according to partly known decomposition processes, often carried out in aggressive media, such as molten nitrate or chlorate at high temperatures, which requires a large amount of material. The disadvantages of known decomposition processes can be partly avoided particularly by pre-treatment using a reducing agent.

Furthermore, it was surprisingly discovered, that the decomposition of supported catalyst material can be facilitated if, e.g., the volatilisation of the solid ruthenium components is considerably accelerated into the gas phase at increased temperature if ozone and/or chlorine and/or hydrogen chloride, e.g. in the form of Cl₂ or HCl, is also present in an oxygen-containing gas stream.

### EMBODIMENTS OF THE INVENTION

An embodiment of the present invention is a process for recovering ruthenium in the form of ruthenium halide from a ruthenium-containing catalyst material on a carrier comprising a) chemically decomposing said ruthenium-containing catalyst material, b) producing a raw ruthenium salt solution, c) purifying said raw ruthenium salt solution to form a purified ruthenium compound, and d) treating said purified ruthenium compound of c) with hydrogen halide or hydrohalic acid to obtain a ruthenium halide.

Another embodiment of the present invention is the above process, wherein said purifying in c) is achieved by stripping gaseous ruthenium tetroxide from said raw ruthenium salt solution, wherein said purified ruthenium compound is gaseous ruthenium tetroxide, and wherein said gaseous ruthenium tetroxide is treated with hydrogen chloride or hydrochloric acid to obtain ruthenium chloride.

Another embodiment of the present invention is the above process, wherein said ruthenium-containing catalyst material is exposed prior to a) to a hydrogen-containing atmosphere to reduce the ruthenium compound.

Another embodiment of the present invention is the above process, wherein said ruthenium-containing catalyst material is purified from sulfur compounds by exposure to an oxygen-containing atmosphere.

Another embodiment of the present invention is the above process, wherein said ruthenium-containing catalyst material originates from a used catalyst for the gas phase oxidation of hydrogen chloride with oxygen or from used electrode material for electrolysis.

Another embodiment of the present invention is the above process, wherein said ruthenium-containing catalyst material comprises a material selected from the group consisting of tin dioxide, silicon dioxide, graphite, titanium, titanium dioxide with rutile or anatase structure, zirconium dioxide, aluminium oxide, silica, carbon nanotubes, nickel, nickel oxide, silicon carbide, tungsten carbide, and mixtures thereof.

Another embodiment of the present invention is the above process, wherein said ruthenium-containing catalyst material contains ruthenium metal or a ruthenium compound selected from the group consisting of ruthenium oxide, ruthenium chloride, and ruthenium chloride oxide.

Another embodiment of the present invention is the above process, wherein the proportion of ruthenium in said ruthenium-containing catalyst material does not exceed 10 wt. %.

Another embodiment of the present invention is the above process, wherein said ruthenium-containing catalyst material is an electrode coating material, wherein the proportion of ruthenium in said electrode coating material does not exceed 50 wt. % in relation to the coating.

Yet another embodiment of the present invention is a catalyst or electrode material comprising a ruthenium halide prepared by the above process, wherein said ruthenium halide comprises, as traces of the total, a total content of Si, Ca, Mg, and Al not greater than 220 ppm; a total content of Rh, Ir, Pt, and Pd not greater than 250 ppm; a content of Cu not greater than 25 ppm; and wherein the individual content of each of K, Na, Fe is not greater than 125 ppm.

Yet another embodiment of the present invention is a process for recovering ruthenium in the form of ruthenium halide from a ruthenium-containing supported catalyst material comprising a′) decomposing said ruthenium-containing supported catalyst material by treating said ruthenium-containing supported catalyst material at a temperature greater than 600° C. in an oxygen-containing atmosphere with a decomposition gas comprising ozone, chlorine, hydrogen chloride, or mixtures thereof to form a volatile, purified ruthenium compound, and b′) treating said volatile, purified ruthenium compound of a′) with hydrogen halide or hydrohalic acid to obtain a ruthenium halide.

Another embodiment of the present invention is the above process, wherein said volatile, purified ruthenium compound is ruthenium tetroxide and said ruthenium tetroxide is treated with hydrogen chloride or hydrochloric acid to obtain ruthenium chloride.

Another embodiment of the present invention is the above process, wherein the proportion of oxygen present in said decomposition gas in a′) is from 1 to 30 volume %, the proportion of chlorine present in said decomposition gas in a′) does not exceed 95 volume %, the proportion of hydrogen chloride present in said decomposition gas in a′) does not exceed 95 volume %, and the proportion of ozone present in said decomposition gas in a′) does not exceed 20 volume.

Another embodiment of the present invention is the above process, wherein the catalyst material is exposed before a′) to a hydrogen-containing atmosphere to reduce the ruthenium compound.

Another embodiment of the present invention is the above process, wherein said ruthenium-containing catalyst material is purified from sulfur compounds by exposure to an oxygen-containing atmosphere.

Another embodiment of the present invention is the above process, wherein said ruthenium-containing catalyst material originates from a used catalyst for the gas phase oxidation of hydrogen chloride with oxygen or from used electrode material for electrolysis.

Another embodiment of the present invention is the above process, wherein said ruthenium-containing catalyst material comprises a material selected from the group consisting of tin dioxide, silicon dioxide, graphite, titanium, titanium dioxide with rutile or anatase structure, zirconium dioxide, aluminium oxide, silica, carbon nanotubes, nickel, nickel oxide, silicon carbide, tungsten carbide, and mixtures thereof.

Another embodiment of the present invention is the above process, wherein said ruthenium-containing catalyst material contains ruthenium metal or a ruthenium compound selected from the group consisting of ruthenium oxide, ruthenium chloride, and ruthenium chloride oxide.

Another embodiment of the present invention is the above process, wherein the ruthenium halide obtained in step d), particularly ruthenium chloride for the production of new catalyst or electrode material is reused, in particular as a ruthenium, ruthenium oxide, ruthenium chloride or ruthenium chloride oxide supported catalyst or as an electrode coating.

Another embodiment of the present invention is the above process, wherein the proportion of ruthenium in said ruthenium-containing catalyst material does not exceed 10 wt. %.

Another embodiment of the present invention is the above process, wherein said ruthenium-containing catalyst material is an electrode coating material, wherein the proportion of ruthenium in said electrode coating material does not exceed 50 wt. % in relation to the coating.

Yet another embodiment of the present invention is a catalyst or electrode material comprising a ruthenium halide prepared by the above process, wherein said ruthenium halide comprises, as traces of the total, a total content of Si, Ca, Mg, and Al not greater than 220 ppm; a total content of Rh, Ir, Pt, and Pd not greater than 250 ppm; a content of Cu not greater than 25 ppm; and wherein the individual content of each of K, Na, Fe is not greater than 125 ppm.

### DESCRIPTION OF THE INVENTION

The object of the invention is, on the one hand, a process to recover ruthenium in the form of ruthenium halide, particularly ruthenium chloride from a ruthenium-containing supported catalyst material with at least the following steps:
a) chemical decomposition of catalyst material
b) production of raw ruthenium salt solution
c) purification of the raw ruthenium salt solution and optionally strip gaseous ruthenium tetroxide from the solution
d) subsequent treatment of the purified ruthenium compound obtained in c), particularly the ruthenium tetroxide with hydrogen halide or hydrohalic acid to recover ruthenium halide, particularly with hydrogen chloride or hydrochloric acid to recover ruthenium chloride.

A preferred embodiment of the process is given, in which the decomposition a) is carried out by
a1) melting a mixture of catalyst material and oxidising agent and optionally also alkali hydroxide and/or alkali carbonate, preferably sodium hydroxide and/or sodium carbonate,
a2) reacting the mixture at a temperature of 250 to 750° C., particularly from 350 to 700° C.,
a3) cooling the molten mass and dissolving the molten mass in mineral acid, particularly in hydrochloric acid and/or sulfuric acid, in particular preferably in hydrochloric acid,
a4) optionally removing from the solution any undissolved carrier material or other insoluble ingredients and subsequent washing of any undissolved carrier material or other insoluble ingredients with aqueous solvent or mineral acid, particularly in hydrochloric acid and/or sulfuric acid, in particular, preferably in hydrochloric acid, and combining the ruthenium-loaded washing fluidised with the separated raw ruthenium solution.
a5) setting the raw ruthenium solution before and/or after separating a4) of solids to a pH value of maximum 5,
   and preparing b) the raw ruthenium solution.

The fusion decomposition with oxidising agents as such is, for example, particularly described in patents U.S. Pat. No. 4,132,569 or U.S. Pat. No. 4,002,470, whose content is added as disclosure to the invention.

Suitable oxidising agents are preferably oxygen-containing mineral salts, particularly nitrates, chlorates, perchlorates, peroxodisulfates, permanganates, peroxide chromates, dichromates of alkali metals or alkaline earth metals, particularly alkali metals. The oxidising agents can also be present in any number of mixtures/combinations.

For decomposition, commercially available materials such as steel or nickel can be used as construction material for the reactors, due to the preferable dilution of the substances used to oxidise the ruthenium compounds, such as particularly chlorates, nitrates, peroxides, peroxodisulfates or mixtures thereof, by appropriate amounts of alkali hydroxide or alkali carbonate or a mixture thereof. Owing to the relatively simple design structure of the reactors (‘baths’), the cost of replacement after an appropriate operating period is still acceptable. A further decisive factor in the economic viability of this decomposition process is the preferred use of oxidising agents, which can be disposed of with relatively few problems from an ecological point of view after completion of the fusion decomposition. Thus, for example, the use of chlorates, peroxides or peroxodisulfates is preferably offered—since these substances are converted to chlorides, hydroxides or sulfates during the fusion decomposition.

Another further preferred embodiment of the process is where the decomposition a) is carried out by:
a6) dissolving the catalyst material in concentrated mineral acid, particularly in hydrochloric acid and/or sulfuric acid, in particular preferably in hydrochloric acid, preferably with a concentration of at least 20%,
a7) optionally removing from the solution undissolved carrier material or other insoluble ingredients and subsequent washing of undissolved carrier material or other insoluble ingredients with aqueous solvent or mineral acid, particularly in hydrochloric acid and/or sulfuric acid, in particular, preferably in hydrochloric acid, and combining the ruthenium-loaded washing fluidised with the separated raw ruthenium solution,
a8) setting the raw ruthenium solution before and/or after separation a7) of solids to a pH value of maximum 5,
   and preparing b) the raw ruthenium solution.

Due, however, to the quite high chemical inertness of the optionally present oxidic ruthenium compounds compared to acid decomposition, as described above, a prior reduction of the oxides in the metal or at least a lower oxidation state than +IV (RuO₂) can be helpful. The reduction step is described below. After reduction, the ruthenium can be dissolved with acid and the addition of an oxidising agent and RuO₄ can be abstracted in a further procedural stage.

A further object of the invention is a process to recover ruthenium in the form of ruthenium halide, particularly ruthenium chloride from a ruthenium-containing supported catalyst material with at least the following steps:

a′) Decomposition of catalyst material by treating the material at a temperature above 600° C. in an oxygen-containing atmosphere with addition of ozone and/or chlorine and/or hydrogen chloride to strip the ruthenium as a volatile, purified ruthenium compound.
b′) subsequent treatment of the purified ruthenium compound obtained in a′), particularly a ruthenium tetroxide with hydrogen halide or hydrohalic acid to recover ruthenium halide, particularly with hydrogen chloride or hydrochloric acid to recover ruthenium chloride.

As a result of the aforementioned decomposition process at a higher temperature, when the raw ruthenium oxide, which could be re-processed for re-using as a catalyst, is stripped, a material is obtained, which is not of sufficient purity. Thus, in a preferred process, the decomposition is carried out with a further purifying step c), in order to achieve an improvement in content, e.g. of Fe, Cu or Pt. A process is preferred, which is characterised in that the content of oxygen in the decomposition gas in decomposition a′) is 1 to 30 vol. %, particularly 2 to 20 vol. %, the content of chlorine does not exceed 95 vol. %, the content of hydrogen chloride does not exceed 95 vol. % and the content of ozone does not exceed 20 vol. %.

A modification of both processes is also preferred, which is characterised in that the catalyst material is exposed to a hydrogen-containing atmosphere to reduce the ruthenium compound before decomposition a) or a′).

A modification of both processes is also preferred, which is characterised in that the catalyst material is purified from sulfur compounds before decomposition a) or a′), particularly by exposure to an oxygen-containing atmosphere.

A modification of both processes is also preferred, which is characterised in that the catalyst material originates from a used catalyst for gas phase oxidation of hydrogen chloride with oxygen or from used electrode material for electrolysis.

A modification of both processes is also preferred, which is characterised in that the catalyst material contains as carrier material a material from the following: tin dioxide, silicon dioxide, graphite, titanium, titanium dioxide with rutile or anatase structure, zirconium dioxide, aluminium oxide, siliceous earth, carbon nanotubes, nickel, nickel oxide, silicon carbide and tungsten carbide or mixtures thereof, preferably tin dioxide, titanium dioxide, zirconium dioxide, aluminium oxide.

A modification of both processes is also preferred, which is characterised in that the catalyst material contains ruthenium as a metal or in the form of a ruthenium compound selected from the following: ruthenium oxide, ruthenium chloride ruthenium chloride oxide.

Purifying c) in both aforementioned processes is preferably carried out by the raw solution undergoing purifying by means of ion exchange, recrystallisation and particularly by stripping gaseous ruthenium tetroxide.

A process is also preferred, which is characterised in that the ruthenium halide recovered in stage d), particularly ruthenium chloride, is re-used to produce new catalyst or electrode material, particularly as a ruthenium, ruthenium oxide, ruthenium chloride or ruthenium chloride oxide supported catalyst or as an electrode coating.

The ruthenium content in the catalyst material typically does not exceed 10 wt. %, particularly 1 to 5 wt. %, in particular preferably 1.5 to 4 wt. %.

The ruthenium content in the coating of the electrode material typically does not exceed 50 wt. %, particularly 30 to 45 wt. %, in particular preferably 35 to 40 wt. %.

It can be advantageous in some ruthenium compounds to first reduce the noble metal in a hydrogen atmosphere in order to then strip the ruthenium components.

The stripped ruthenium can then be absorbed in a solution and further processed. In this respect, a hydrochloric acid solution is preferably suitable, in which the ruthenium compound is converted to ruthenium chloride. Ruthenium chloride is a type of compound that is particularly preferred in the production of catalysts.

A particular advantage of the invention was found to be that the ruthenium salt (particularly RuCl₃), formed by absorption of RuO₄ in the mineral salt, displays a very high purity, which is necessary when using RuCl₃ as starting material in catalyst production, particularly for the Deacon procedure or for electrolysis. The ruthenium salt obtained according to the preferred process, particularly ruthenium chloride, displays as traces of the total a content of Si, Ca, Mg and Al of maximum 220 ppm, in particular preferably maximum 150 ppm, a content of Rb, Ir, Pt and Pd of the total of maximum 250 ppm, in particular preferably maximum 150 ppm, a content of Cu of maximum 25 ppm, in particular preferably maximum 15 ppm and a content of K, Na, Fe each of maximum 125 ppm, in particular preferably maximum 100 ppm.

This high purity grade is only achievable with considerable effort by conventional, known methods alone, such as e.g. recrystallisation of salts.

A first oxidation or reduction stage carried out at lower temperatures than actual volatilisation can also have the considerable advantage with the used catalyst of carrying out a first purifying stage. Secondary components such as deposited carbon, sulfur compounds, etc. can then already be separated from the surface of the catalyst.

However, other preceding purifying stages, such as washing out, possibly with acids, the ruthenium compound on a carrier are also applicable here. This pre-purification then enables the ruthenium compound to be more efficiently volatilized, in that the noble metal is more accessible, as well as simplifying the purifying of the noble metal in the next step.

Such a method offers a significant advantage, as the expulsion times for ruthenium are markedly shortened. In addition, the ruthenium does not need to be put in solution in a previous step, an effort that should not be discounted. Furthermore, it is a very environmentally-friendly and economic method, since, by omitting carrier decomposition, no molten salts are used. The costs of these molten salts are not inconsiderable, as their necessary disposal afterwards is costly and time-consuming.

Ruthenium-containing electrode material can be used in the process according to the invention without first separating the ruthenium-containing components or after separating ruthenium-containing components. In this arrangement, both mechanical methods such as sand blasting with aluminates or silicates, etc. and chemical methods can be used.

The coating separated from the electrode remains and further purifying is required due to foreign bodies from the previous sand blasting.

The recovered ruthenium according to the process according to the invention can subsequently be re-used in the production of catalysts or electrodes.

Moreover, an object of the invention is thus the use of the recovered ruthenium compound obtained from the process according to the invention as catalyst or electrode material, particularly as a ruthenium, ruthenium oxide, ruthenium chloride or ruthenium chloride oxide supported catalyst or as an electrode coating.

It is particularly preferred that the recovered ruthenium compound according to the process according to the invention is used in the catalytic process known as the Deacon procedure. In this arrangement, hydrogen chloride plus oxygen is oxidised to chlorine in an exothermal balanced equation, water vapour being developed. The reaction temperature is normally 150 to 500° C., the normal reaction pressure is 1 to 25 bar. As this is a balanced equation, it is sensible to work at the lowest possible temperatures at which the catalyst still displays sufficient activity. Furthermore, it is sensible to use oxygen in greater stoichiometric quantities than hydrogen chloride. For example, a twofold to fourfold excess of oxygen is normal. As there is no risk of selectivity losses, it can be of economic advantage to operate at relatively high pressure and correspondingly with a longer residence time than for normal pressure.

Preferred suitable catalysts for the Deacon process usually contain ruthenium oxide, ruthenium chloride ruthenium chloride oxide or other ruthenium compounds on carriers of silicon dioxide, aluminium oxide, titanium dioxide or zirconium dioxide. Suitable catalysts can, for example, be obtained by applying ruthenium chloride to the carrier and subsequent drying or drying and calcination. In addition to the ruthenium compound, suitable catalysts can also contain compounds of other noble metals, for example, gold, palladium, platinum, osmium, iridium, silver, copper or rhenium. Moreover, suitable catalysts can additionally contain chromium oxide.

The catalytic hydrogen chloride oxidation can be carried out preferably adiabatically or isothermally or approximately isothermally, in batches, but preferably continuously as a fluidised or fixed-bed process, preferably as a fixed-bed process, in particular preferably in tube bundle reactors on heterogeneous catalysts at a reactor temperature of 180 to 500° C., preferably 200 to 400° C., in particular preferably 220 to 350° C. and pressure of 1 to 25 bar (1000 to 25000 hPa), preferably 1.2 to 20 bar, in particular preferably 1.5 to 17 bar and particularly 2.0 to 15 bar.

Normal reaction apparatus, in which the catalytic hydrogen chloride oxidation is carried out, is fixed-bed or fluidised-bed reactors. The catalytic hydrogen chloride oxidation can preferably also be carried out in several stages.

In the adiabatic, isothermal or approximately isothermal operation, several reactors switched in series with intermediate cooling can be used, i.e. 2 to 10, preferably 2 to 6, in particular preferably 2 to 5, particularly 2 to 3. The hydrogen chloride can either be fed in total together with the oxygen before the first reactor or be distributed across the different reactors. This series mounting of individual reactors can also be combined in one piece of apparatus.

A further preferred embodiment of a suitable device for the process consists in using a structured catalyst bed, where the catalytic activity increases in the direction of stream. Such a structuring of the catalyst bed can be effected through differing saturation of the catalyst carriers with active substance or through differing dilution of the catalyst with an inert material. Inert materials, for example rings, cylinders or balls of titanium dioxide, zirconium dioxide or mixtures thereof, aluminium oxide, steatite, ceramic, glass, graphite or stainless steel, can be used. In the preferred use of catalyst forms, the inert material should preferably have similar external dimensions.

Forms of any shape are suitable as catalyst forms, the preferred forms are tablets, rings, cylinders, stars, cart wheels or balls, in particular preferred are rings, cylinders or star strings.

Ruthenium compounds or copper compounds on carrier materials, that can also be doped, are particularly suitable as heterogeneous catalysts, optionally doped ruthenium catalysts are preferred. As new carrier materials, the following examples are suitable: tin dioxide, silicon dioxide, graphite, titanium dioxide with rutile or anatase structure, zirconium dioxide, aluminium oxide or mixtures thereof, preferably tin dioxide, titanium dioxide, zirconium dioxide, aluminium oxide or mixtures thereof particularly preferred γ- or δ-aluminium oxide or mixtures thereof.

The copper carrier catalysts and ruthenium carrier catalysts can be obtained for example by saturating the carrier material with aqueous solutions of CuCl₂ or RuCl₃ and optionally a promoter for doping preferably in the form of their chlorides. The shaping of the catalyst can occur after or preferably before saturating the carrier material.

Suitable promoters for doping catalysts are alkali metals, such as lithium, sodium, potassium, rubidium and caesium, preferably lithium, sodium and potassium, in particular preferred potassium, alkaline earth metals such as magnesium, calcium, strontium and barium, preferably magnesium and calcium, in particular preferred magnesium, rare earth metals such as scandium, yttrium, lanthanum, cerium, praseodymium and neodymium, preferably scandium, yttrium, lanthanum and cerium, in particular preferred lanthanum and cerium, or mixtures thereof.

The forms can then be dried at a temperature of 100 to 400° C., preferably 100 to 300° C. for example in a nitrogen, argon or air atmosphere and optionally calcined. The forms are preferably first dried at 100 to 150° C. and then calcined at 200 to 400° C.

The conversion of hydrogen chloride in a single cycle can be preferably restricted to 15 to 90%, preferably 40 to 85%, in particular preferred 50 to 70%. After separation, unconverted hydrogen chloride can be partially or fully returned to the catalytic hydrogen chloride oxidation. The volume ratio of hydrogen chloride to oxygen at the reactor inlet is preferably 1:1 to 20:1, preferably 2:1 to 8:1, in particular preferably 2:1 to 5:1.

In a last step, the chlorine formed is separated. The separating step usually includes several stages, namely the separation and optional return of unconverted hydrogen chloride from the product gas stream of the catalytic hydrogen chloride oxidation, the drying of the stream obtained, mainly containing chlorine and oxygen, and the separation of chlorine from the dried stream.

### EXAMPLES

### Example 1

4.5 g catalyst balls (RuCl₃/SnO₂,Al₂O₃; 2 wt.-% Ru, 1.5 mm) were coated with 2.9 g SiO₂ balls (SS62138, Saint Gobain, 1.5 mm) in a sand fluidised bed heated quartz glass reactor (i.d. 10 mm). The catalyst bed was heated at a constant temperature of 682° C., the silicon dioxide particles were subjected to a temperature gradient of over 532° C. between the catalyst bed and the reactor outlet. HCl at 20 ml/min (STP) and O₂ at 80 ml/min (STP) were streamed through the reactor for 8 h. The hydrogen chloride was partially converted with the oxygen to chlorine and water. The reaction gas was directed into 15% HCl and absorbed. The analysis showed a recovery of 76% of Ru as RuCl₃.

### Example 2

5.3 g catalyst balls (RuCl₃/SnO₂,Al₂O₃; 2 wt.-% Ru, 1.5 mm) were coated with 1.7 g SiO₂ balls (SS62138, Saint Gobain, 1.5 mm) in a sand fluidised bed heated quartz glass reactor (id. 10 mm). The catalyst bed was heated at a constant temperature of 687° C., the silicon dioxide particles were subjected to a temperature gradient of over 537° C. between the catalyst bed and the reactor outlet. N₂ at 160 ml/min (STP) and O₂ at 80 ml/min (STP) were streamed through the reactor for 8 h. The hydrogen chloride was partially converted with the oxygen to chlorine and water. The reaction gas was directed into 15% HCl and absorbed. The analysis showed a recovery of only 7.2% of Ru as RuCl₃.

Compared to Example 1, it appears that O₂ together with HCl should be optionally used. This enables the chlorine-containing atmosphere (Cl₂ and/or HCl) to support significantly more stripping of RuO₄.

### Example 3

### Decomposition of Ruthenium Chloride Oxide-Catalyst

2-2.5 g ruthenium chloride oxide catalyst, i.e. a used ruthenium chloride catalyst, calcined in the presence of air, which had been used in a Deacon process, and a magnetic stirrer were introduced into a three-neck bottle with reflux condenser; dropping funnel, N₂ feed (0.25 l/min). (Both a SnO₂ and a TiO₂ supported catalyst were used independently of each other). The outlet of the three-neck bottle was connected to two wash bottles—the adjacent N₂ flushing was directed through the wash bottles. The first was filled with a 15 wt. % hydrochloric acid, the second with a 15 wt. % soda solution.

Approx. 100 ml HCl (cone.) was added and heated to boiling while being stirred.

After approx. 2 h boiling with reflux, 20 g NaClO₃ in a solution form were slowly added via dropping funnel under N₂ flushing. The addition time took approx. 30 min.

The content of the three-neck bottle was boiled with reflux for a further 2 h with N₂ flushing, then cooled under N₂ flushing and a sample taken from the clear residue. 2 and 1% of the ruthenium quantity contained in the catalyst was recovered (SnO₂ and TiO₂ carriers respectively) in the clear residue of the decomposition solution. 16% and 13% of the ruthenium quantity contained in the catalyst was able to be recovered (SnO₂ and TiO₂ carriers respectively) in the adjacent-connected HCl wash bottle.

No ruthenium could be detected in the NaOH wash bottle.

### Example 4

The decomposition method shown in example 3 of an oxidic Ru catalyst produced a still comparably small recovery rate. Thus, reduction with hydrogen was applied before, which caused a considerable increase in the recovery rate.

In this respect, 3 g ruthenium chloride oxide catalyst (SnO₂ and TiO₂ supported) were overflowed for 2 h in a reaction tube with a gas mixture of 4% H₂/96% N₂ at 550° C. and at least partly reduced to metal Ru.

The catalyst treated in this way was decomposed with HCl/NaClO₃ similar to example 3. The yield obtained, after analysing the HCl wash bottle produced 74 and 65% (SnO₂ and TiO₂ supported, respectively). Only a small part of the catalyst carrier was dissolved and displayed an almost white colour. 1% each of the ruthenium quantity contained in the catalyst was recovered (SnO₂ and TiO₂ carriers, respectively) in the clear residue of the decomposition solution.

### Example 5

Decomposition of ruthenium chloride oxide catalyst (SnO₂ and TiO₂ supported, respectively)—NaOH/KNO₃ fusion.

2 g ruthenium chloride oxide catalyst (SnO₂ and TiO₂ carriers, respectively) were ground in a mortar with 9 g NaOH (solid) and 4 g KNO₃. The mixture was then brought to reaction at 500° C./2 h in a melting crucible of 50 ml size.

After cooling, the fusion cake was decomposed in the following way:

The fusion cake was fed into a three-neck bottle with reflux condenser; dropping funnel, N₂ feed (0.25 l/min. The outlet of the three-neck bottle was connected to two wash bottles—the adjacent N₂ flushing was directed through the wash bottles. The first was filled with a 15 wt. % hydrochloric acid, the second with a 15 wt. % soda solution.

Approx. 100 ml HCl (conc.) was added and heated to boiling while being stirred.

After approx. 2 h boiling with reflux, 20 g NaClO₃ in a solution form were slowly added via dropping funnel under N₂ flushing. The addition time took approx. 30 min.

The content of the three-neck bottle was boiled with reflux for approx. 2 h with N₂ feeding, then cooled under N₂ flushing and a sample taken from the clear residue.

2 and 1% of the ruthenium quantity contained in the catalyst was recovered (SnO₂ and TiO₂ carriers, respectively) in the clear residue of the decomposition solution. 76% and 73% of the ruthenium quantity contained in the catalyst was able to be recovered (SnO₂ and TiO₂ carriers respectively) in the adjacent-connected HCl wash bottle.

No ruthenium could be detected in the NaOH wash bottle.

### Example 6

### Decomposition of Ruthenium Chloride Oxide Catalyst (SnO₂ and TiO₂ Supported, Respectively)—NaOH/Na₂CO₃/KNO₃ Fusion

Example 5 was repeated with a weighed portion of 5 g NaOH/4 g Na₂CO₃ instead of 9 g NaOH—the course and processing were similar to example 5.

1 and 3% of the ruthenium quantity contained in the catalyst was recovered (SnO₂ and TiO₂ carriers, respectively) in the clear residue of the decomposition solution. 82% and 79% of the ruthenium quantity contained in the catalyst was able to be recovered (SnO₂ and TiO₂ carriers, respectively) in the adjacent-connected HCl wash bottle.

All the references described above are incorporated by reference in its entirety for all useful purposes.

While there is shown and described certain specific structures embodying the invention, it will be manifest to those skilled in the art that various modifications and rearrangements of the parts may be made without departing from the spirit and scope of the underlying inventive concept and that the same is not limited to the particular forms herein shown and described.

1. A process for recovering ruthenium in the form of ruthenium halide from a ruthenium-containing catalyst material on a carrier comprising:
a) chemically decomposing said ruthenium-containing catalyst material;
b) producing a raw ruthenium salt solution;
c) purifying said raw ruthenium salt solution to form a purified ruthenium compound; and
d) treating said purified ruthenium compound of c) with hydrogen halide or hydrohalic acid to obtain a ruthenium halide.

2. The process of claim 1, wherein said purifying in c) is achieved by stripping gaseous ruthenium tetroxide from said raw ruthenium salt solution, wherein said purified ruthenium compound is gaseous ruthenium tetroxide, and wherein said gaseous ruthenium tetroxide is treated with hydrogen chloride or hydrochloric acid to obtain ruthenium chloride.

3. The process of claim 1, wherein said ruthenium-containing catalyst material is exposed prior to a) to a hydrogen-containing atmosphere to reduce the ruthenium compound.

4. The process of claim 1, wherein said ruthenium-containing catalyst material is purified from sulfur compounds by exposure to an oxygen-containing atmosphere.

5. The process of claim 1, wherein said ruthenium-containing catalyst material originates from a used catalyst for the gas phase oxidation of hydrogen chloride with oxygen or from used electrode material for electrolysis.

6. The process of claim 1, wherein said ruthenium-containing catalyst material comprises a material selected from the group consisting of tin dioxide, silicon dioxide, graphite, titanium, titanium dioxide with rutile or anatase structure, zirconium dioxide, aluminium oxide, silica, carbon nanotubes, nickel, nickel oxide, silicon carbide, tungsten carbide, and mixtures thereof.

7. The process of claim 1, wherein said ruthenium-containing catalyst material contains ruthenium metal or a ruthenium compound selected from the group consisting of ruthenium oxide, ruthenium chloride, and ruthenium chloride oxide.

8. The process of claim 1, wherein the proportion of ruthenium in said ruthenium-containing catalyst material does not exceed 10 wt. %.

9. The process of claim 1, wherein said ruthenium-containing catalyst material is an electrode coating material, wherein the proportion of ruthenium in said electrode coating material does not exceed 50 wt. % in relation to the coating.

10. A catalyst or electrode material comprising a ruthenium halide prepared by the process of claim 1, wherein said ruthenium halide comprises, as traces of the total, a total content of Si, Ca, Mg, and Al not greater than 220 ppm; a total content of Rh, Ir, Pt, and Pd not greater than 250 ppm; a content of Cu not greater than 25 ppm; and wherein the individual content of each of K, Na, Fe is not greater than 125 ppm.

11. A process for recovering ruthenium in the form of ruthenium halide from a ruthenium-containing supported catalyst material comprising:
a′) decomposing said ruthenium-containing supported catalyst material by treating said ruthenium-containing supported catalyst material at a temperature greater than 600° C. in an oxygen-containing atmosphere with a decomposition gas comprising ozone, chlorine, hydrogen chloride, or mixtures thereof to form a volatile, purified ruthenium compound; and
b′) treating said volatile, purified ruthenium compound of a′) with hydrogen halide or hydrohalic acid to obtain a ruthenium halide.

12. The process of claim 11, wherein said volatile, purified ruthenium compound is ruthenium tetroxide and said ruthenium tetroxide is treated with hydrogen chloride or hydrochloric acid to obtain ruthenium chloride.

13. The process of claim 11, wherein the proportion of oxygen present in said decomposition gas in a′) is from 1 to 30 volume %, the proportion of chlorine present in said decomposition gas in a′) does not exceed 95 volume %, the proportion of hydrogen chloride present in said decomposition gas in a′) does not exceed 95 volume %, and the proportion of ozone present in said decomposition gas in a′) does not exceed 20 volume.

14. The process of claim 11, wherein the catalyst material is exposed before a′) to a hydrogen-containing atmosphere to reduce the ruthenium compound.

15. The process of claim 11, wherein said ruthenium-containing catalyst material is purified from sulfur compounds by exposure to an oxygen-containing atmosphere.

16. The process of claim 11, wherein said ruthenium-containing catalyst material originates from a used catalyst for the gas phase oxidation of hydrogen chloride with oxygen or from used electrode material for electrolysis.

17. The process of claim 1, wherein said ruthenium-containing catalyst material comprises a material selected from the group consisting of tin dioxide, silicon dioxide, graphite, titanium, titanium dioxide with rutile or anatase structure, zirconium dioxide, aluminium oxide, silica, carbon nanotubes, nickel, nickel oxide, silicon carbide, tungsten carbide, and mixtures thereof.

18. The process of claim 11, wherein said ruthenium-containing catalyst material contains ruthenium metal or a ruthenium compound selected from the group consisting of ruthenium oxide, ruthenium chloride, and ruthenium chloride oxide.

19. The process of claim 11, wherein the ruthenium halide obtained in step d), particularly ruthenium chloride for the production of new catalyst or electrode material is reused, in particular as a ruthenium, ruthenium oxide, ruthenium chloride or ruthenium chloride oxide supported catalyst or as an electrode coating.

20. The process of claim 11, wherein the proportion of ruthenium in said ruthenium-containing catalyst material does not exceed 10 wt. %.

21. The process of claim 11, wherein said ruthenium-containing catalyst material is an electrode coating material, wherein the proportion of ruthenium in said electrode coating material does not exceed 50 wt. % in relation to the coating.

22. A catalyst or electrode material comprising a ruthenium halide prepared by the process of claim 11, wherein said ruthenium halide comprises, as traces of the total, a total content of Si, Ca, Mg, and Al not greater than 220 ppm; a total content of Rh, Ir, Pt, and Pd not greater than 250 ppm; a content of Cu not greater than 25 ppm; and wherein the individual content of each of K, Na, Fe is not greater than 125 ppm.
